(19) United States
(12) Patent Application Publication
(10) Pub. No.: US 2021/0039743 A1
(43) Pub. Date: Feb. 11, 2021

(54) CARGO BICYCLE WHICH CAN BE DRIVEN USING MUSCLE POWER AND/OR AN ELECTRIC DRIVE

(71) Applicant: TRETBOX GMBH, Berlin (DE)

(72) Inventor: Philipp KAHLE, Berlin (DE)

(73) Assignee: TRETBOX GMBH, Berlin (DE)

(21) Appl. No.: 16/932,896

(22) Filed: Jul. 20, 2020

(30) Foreign Application Priority Data
Aug. 5, 2019 (DE) 102019121141.7

(51) Int. Cl. B62M 6/40; B62J 17/086; B62J 6/22; B62J 50/00; B62M 3/08; B62K 7/00

(52) U.S. Cl. CPC B62M 6/40; B62J 17/086; B62K 7/00; B62J 50/00; B62M 3/08; B62J 6/22

(57) ABSTRACT

A cargo bicycle which can be driven using muscle power and/or an electric drive, with at least one pick-up area in or on which or at least one swap body and/or an additional load can be or is positioned and with at least one driver area which is positioned in front of the pick-up area in regard to the direction of travel of the cargo bicycle and which includes at least one seat unit, one pedal unit, one steering unit, one flashing roof element at least over the driver area and one at least area by area limiting floor plate of a floor unit in the driver area in the direction of the travel surface. The floor plate and roof element include at least an area by area distance to one another which is at least the body size of an operator.

### CROSS REFERENCE TO RELATED APPLICATIONS

This application claims the benefit of German priority application DE 10 2019 121 141.7, filed Aug. 5, 2019, which is incorporated by reference.

### FIELD OF THE INVENTION

The invention concerns a cargo bicycle which can be driven using muscle power and/or an electric drive.

### BACKGROUND

Cargo bicycles exist in various designs. For example, they may have a rickshaw design in order to transport people or a cargo bicycle design for the transportation of containers or other additional loads.

The cargo bicycles may be powered solely through muscle power or at least minimally supported by an electric drive.

A manually staffed pick-up area is generally required for loading and unloading the cargo bicycle. This has proven awkward in existing cargo bicycles, in particular from the direction of the driver area, which essentially blocks access to the pick-up area.

Moreover, the cargo bicycles which have been developed have a limited capacity to transport additional passengers.

### SUMMARY OF THE INVENTION

One object of one embodiment of this invention is to present a cargo bicycle which improves accessibility in the pick-up area.

This object was solved by a cargo bicycle which can be driven using muscle power and/or an electric drive, with at least one pick-up area in or on which or at least one swap body and/or an additional load can be or is positioned and with at least one driver area which is positioned in front of the pick-up area in regard to the direction of travel of the cargo bicycle and which includes at least one seat unit, one pedal unit, one steering unit, one flashing roof element at least over the driver area and one at least area by area limiting floor plate of a floor unit in the driver area in the direction of the travel surface, whereby the floor plate and roof element include at least an area by area distance to one another which is at least the body size of an operator.

Due to the fact that the floor plate and the roof element demonstrate at least an area by area distance to one another which is at least the body size of the operator, the pick-up area is also easily accessible from the driver area. This can simplify loading and unloading of the pick-up area.

For example, the cargo bicycle can be driven using muscle power and/or an electric drive. In such a case it can include a so-called load-pedelec.

If the floor plate and the roof element only demonstrate distance to one another which is at least the body size of the operator in one area, it has proven advantageous if this area is positioned on the side of the driver area which faces the pick-up area. This can guarantee that the operating person can stand upright in the driver area while the swap body and/or additional load is being positioned or removed again in the pick-up area.

Cargo bicycle designs are conceivable where the distance between the floor plate and roof element comprises at least 1.70 m, in particular at least 1.80 m, in particular 1.90 m, in particular 2.00 m.

The floor plate can be developed in a crampon or step manner, for example, and only positioned in the driver area which faces the pick-up area. However, it has proven advantageous if the floor plate forms at least an almost closed surface, which can or does entirely or almost entirely close off the driver area to the travel surface.

If the floor plate forms an almost entirely closed surface which closes off the driver area to the travel surface is almost entirely, the floor plate simultaneously provides a splash guard. This reduces the penetration of dirt and moisture at least in the driver area, for example, when riding the cargo bicycle on wet ground.

The design of the cargo bicycle anticipates that at least the seat unit and/or the steering unit can be or are fixed to the floor plate.

In such a case, the floor plate serves as an additional supporting element, for example of a frame construction of the cargo bicycle. This means additional supporting struts which fix the seating unit and/or the steering unit in the driver area of the cargo bicycle are not required.

In order to reduce the risk of an accident and/or the risk of injury to personnel operating the cargo bicycle, it proves advantageous if at least a section of the floor plate on the driver area facing side includes a coating which increases the roughness, such as a fiber coating, plastic coating, metal coating, or similar that has indentations, protrusions, or surface roughness.

This makes it possible to increase the slip resistance of the floor plate, thereby reducing the chance of slipping or sliding of the operating personnel when standing, entering or leaving the driver area.

Furthermore, it proves advantageous if the floor plate includes at least one drainage facility through which the fluid can drain from the driver area. For example, this can include a drainage hole or pump and sump for collection of fluid.

This guarantees that if an operator exits and re-enters the driver area whilst it is raining, the water dripping from the operator can drain from the driver area.

This reduces puddling in the driver area which makes it possible to further increase the safety of the operator.

Furthermore, it is anticipated in the design of the cargo bicycle that the driver area includes an essentially externally closed off cabin which includes an opening which is slanted or diagonal to the direction of travel through which the driver area is accessible from outside.

This further reduces the possibility of dirt and/or moisture penetrating into the driver area.

If the cargo bicycle is used to transport swap bodies or similar and an additional operator is anticipated to this end, it could prove advantageous if the floor plate includes at least one step, which protrudes in particular in the area of the opening and out of the driver area.

The step can be in the shape of a running board.

It is conceivable in principle that the swap bodies are pushed into a pick-up area directly through the opening and fixed there. This enables the swap bodies to be lifted for transport or include wheels or rollers with which the swap bodies can be moved with the cargo bicycle. It is anticipated in the design of the cargo bicycle that the floor unit includes a planar pick-up floor which is at least closed off from the pick-up area in the direction of the travel surface, through which the pick-up area can be or is entirely or at least almost entirely closed off from the travel surface.

In such a case the swap bodies can be simply pushed onto the planar pick-up floor.

As a further development of the last mentioned design, it proves advantageous if the floor plate and the pick-up floor comprise of a joint, one piece component.

In this case, the cargo bicycle can have a compact design with minimal components.

Moreover, it is anticipated in the design of the cargo bicycle that the floor plate and/or pick-up floor on the side facing towards or away from the travel surface is fixed to a support structure of the cargo bicycle to which at least one wheel unit can be or is positioned.

If the floor plate and/or the pick-up floor is fixed to support structure of the cargo bicycle on a side facing the travel surface, the cargo bicycle is set deeper in relation to its height. This makes it possible to reduce the air resistance of the cargo bicycle.

Further features, details and advantages of the invention will become apparent from the appended claims, the drawings and the following description of a preferred embodiment of the cargo bicycle.

### BRIEF DESCRIPTION OF THE DRAWINGS

The drawing shows:

FIG. 1 A perspective front view of an example of the design of the cargo bicycle;

FIG. 2 A perspective side view of a driver area of the cargo bicycle according to FIG. 1.

### DETAILED DESCRIPTION OF THE INVENTION

The Figures show an embodiment of the cargo bicycle that is labelled with the reference number 2 as a whole. Cargo bicycle 2 can be driven using muscle power and/or an electric drive. Cargo bicycle 2 includes pick-up area 4 in which at least one swap body (not depicted in the Figure) and/or one additional load can be or is positioned. Moreover, cargo bicycle 2 includes driver area 6 which is positioned in front of the pick-up area 4 in relation to the driving direction 9 of cargo bicycle 2.

In driver area 6 there is seat unit 8, pedal unit 10, steering unit 12, flashing roof element 14 over at least driver area 6 as well as a floor plate 18 which closes of at least an area in the direction of the travel surface 16 of floor unit 20 in driver area 6.

In the embodiment of cargo bicycle 2 shown in the Figures, floor plate 18 and roof element 14 demonstrate a distance to one another which is at least the body size of the operator.

Floor plate 18 includes an almost closed surface. Here, driver area 6 is almost completely closed off to travel surface 18. Seat unit 8 and steering unit 12 are fixed to floor plate 18.

Driver area 6 includes an almost completely externally closed cabin. This shows opening 22, diagonally to direction of travel 8, through which driver area 6 is accessible from outside.

In addition to floor plate 18, in pick-up area 4, floor unit 20 includes planar pick-up floor 24, which is closed off to pick-up area 4 in the direction of travel surface 16. A swap body and/or additional load can be positioned on pick-up floor 24.

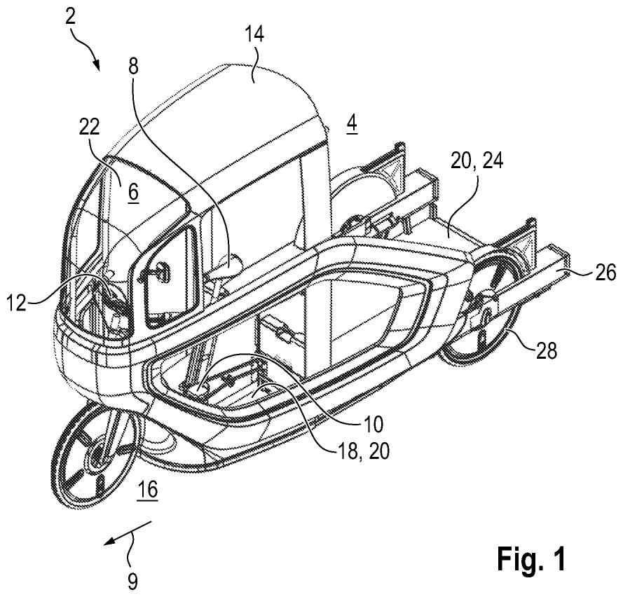

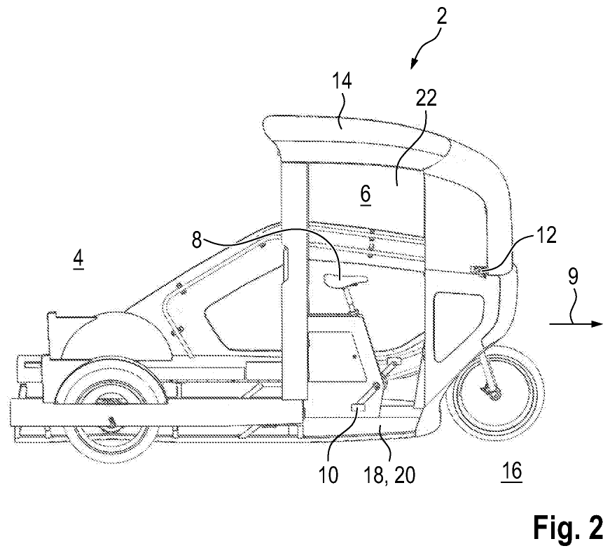

FIGS. 1 and 2 show an embodiment of cargo bicycle 2 in which pick-up floor 24 and floor plate 18 incorporate a joint, one-piece component. Floor plate 18 and pick-up floor 24 are fixed to a travel surface 16 facing side in relation to support structure 26 of cargo bicycle 2 to which at least wheel unit 28 can be positioned. This means cargo bicycle 2 has a particularly low height.

The functionality of cargo bicycle 2 is described below:

An operator of cargo bicycle 2 in driver area 6 can be positioned for the loading and unloading of pick-up area 4 and stand upright to support the loading of pick-up area 4. The same applies for the unloading of pick-up area 4, where the operator of cargo bicycle 2 can select the swap body and/or additional load from driver area 6.

The features of the invention disclosed in the above description, in the claims and in the drawing, may be essential both individually and in any combination in the realisation of the invention in its various embodiments.

### REFERENCE LIST

2 Cargo bicycle

4 Pick-up area

6 Driver area

8 Seat unit

9 Direction of travel

10 Pedal unit

12 Steering unit

14 Roof element

16 Travel surface

18 Floor plate

20 Floor unit

22 Opening

24 Pick-up floor

26 Support structure

28 Wheel unit

1. A cargo bicycle which can be driven using muscle power and/or an electric drive, with at least one pick-up area in or on which or at least one swap body and/or an additional load can be or is positioned and with at least one driver area which is positioned in front of the pick-up area in regard to the direction of travel of the cargo bicycle and which comprises:
at least one seat unit,
one pedal unit,
one steering unit,
one flashing roof element at least over the driver area, and
one at least area by area limiting floor plate of a floor unit in the driver area in the direction of the travel surface,
wherein the floor plate and roof element include at least an area by area distance to one another which is at least the body size of an operator.

2. The cargo bicycle according to claim 1, wherein the distance between the floor plate and roof element is at least 1.70 m, in particular at least 1.80 m, in particular 1.90 m, in particular 2.00 m.

3. The cargo bicycle according to claim 1, wherein the floor plate forms at least an almost closed surface, through which the driver area is entirely or at least almost entirely closed off to the travel surface.

4. The cargo bicycle according to claim 1, wherein at least the seat unit and/or steering unit can be or are fixed to the floor plate.

5. The cargo bicycle according to claim 1, wherein the floor plate incorporates a coating which increases roughness at least sectionally on the side facing the driver area.

6. The cargo bicycle according to claim 1, wherein the floor plate incorporates at least one drainage facility through which fluid can drain out of the driver area.

7. The cargo bicycle according to claim 1, wherein the driver area incorporates an essentially externally closed cabin which includes an opening which is slanted or diagonal to the direction of travel through which the driver area can be accessed from the outside.

8. The cargo bicycle according to claim 1, wherein the floor plate incorporates at least one step which protrudes in particular in the area of the opening and the driver area.

9. The cargo bicycle according to claim 1, wherein the floor unit at least includes a planar pick-up floor which is at least closed off from the pick-up area in the direction of the travel surface, through which the pick-up area can be or is entirely or at least almost entirely closed off to the travel surface.

10. The cargo bicycle according to claim 9, wherein the floor plate and pick-up floor incorporate a joint, one-piece component.

11. The cargo bicycle according to claim 1, wherein the floor plate and/or pick-up floor on one of the sides facing towards or away from the travel surface is fixed or can be fixed to a support structure of the cargo bicycle to which at least one wheel unit can be or is positioned.
